(19) United States
(12) Patent Application Publication
(10) Pub. No.: US 2006/0070486 A1
(43) Pub. Date: Apr. 6, 2006

(54) Extruded steering wheel rim

(76) Inventors: Xiaoping Xu, Rochester Hills, MI (US); Byron Spencer, Bloomfield, MI (US)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 10/949,508

(22) Filed: Sep. 24, 2004

(51) Int. Cl. B62D 1/04

(52) U.S. Cl. 74/552

(57) ABSTRACT

A steering wheel assembly has a steering wheel rim extending around a perimeter. A reinforcing support extends at least partially around the perimeter and is formed on the steering wheel rim. The steering wheel rim has an interior surface and an exterior surface. The reinforcing support protrudes from at least one of the interior surface and the exterior surface.

### BACKGROUND OF THE INVENTION

This invention relates to a steering wheel assembly.

Steering wheel assemblies for a vehicle typically have a steering wheel rim, armature, and spokes extending to a hub within the center of the rim The rim may be formed from rolled metal or, alternatively, a plastic core formed by a mold. A lining or leather wrap may be added to the rim for driver comfort.

Steering wheel assemblies are relatively expensive. Part of the expense arises from the use of durable materials, such as a metal or a solid plastic core, to form the steering wheel rim. These types of materials ensure that the steering wheel has enough rigidity to respond well to inputs from a driver. They are also strong enough to survive the wear and tear that may occur during the operation of the vehicle.

A need therefore exists for a durable and inexpensive steering wheel assembly.

### SUMMARY OF THE INVENTION

The present invention comprises a steering wheel assembly. The steering wheel assembly has a steering wheel rim that extends around a perimeter. The steering wheel rim may be hollow. To strengthen the rim, reinforcing supports extend at least partially around the perimeter on the steering wheel rim. The steering wheel has an interior surface and an exterior surface. These reinforcing supports may protrude from the interior surface, the exterior surface or both surfaces of the rim.

The inventive steering wheel assembly is made from a process of extrusion. Material is extruded through a die. The material is then formed into the shape of a steering wheel rim. Reinforcing supports may be added to the material and may be formed with the rim from the same die. The die may form these supports on an interior surface or an exterior surface of the rim. The steering wheel armature, spoke and hub may be subsequently molded to the extruded steering wheel rim.

By forming the steering wheel rim in this manner, less material is required to construct each steering wheel rim. In addition, the steering wheel rim has sufficient strength from the reinforcing supports extending along the rim to perform well and to be long lasting. Consequently, a steering wheel may be constructed at very low cost while retaining the strength and durability required for normal vehicle operation.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a cross-sectional perspective view of a steering wheel assembly, showing steering wheel rim and reinforcing supports.

FIG. 2 illustrates a cross-sectional view of the steering wheel rim of FIG. 1 formed by a die.

FIG. 3 illustrates an alternative cross-section of a steering wheel rim.

FIG. 4 illustrates another alternative cross-section of a steering wheel rim.

FIG. 5 illustrates another alternative cross-section of a steering wheel rim, including filler material extending around the rim.

FIG. 6 illustrates an extrusion process for forming the steering wheel rim of FIGS. 1-5

FIG. 7 illustrates the separation of the steering wheel rim from the extruded material of FIG. 6.

FIG. 8 illustrates a completed steering wheel rim.

FIG. 9 shows the completed steering wheel rim of FIG. 8 in a mold.

### DETAILED DESCRIPTION OF THE PREFERRED EMBODIMENT

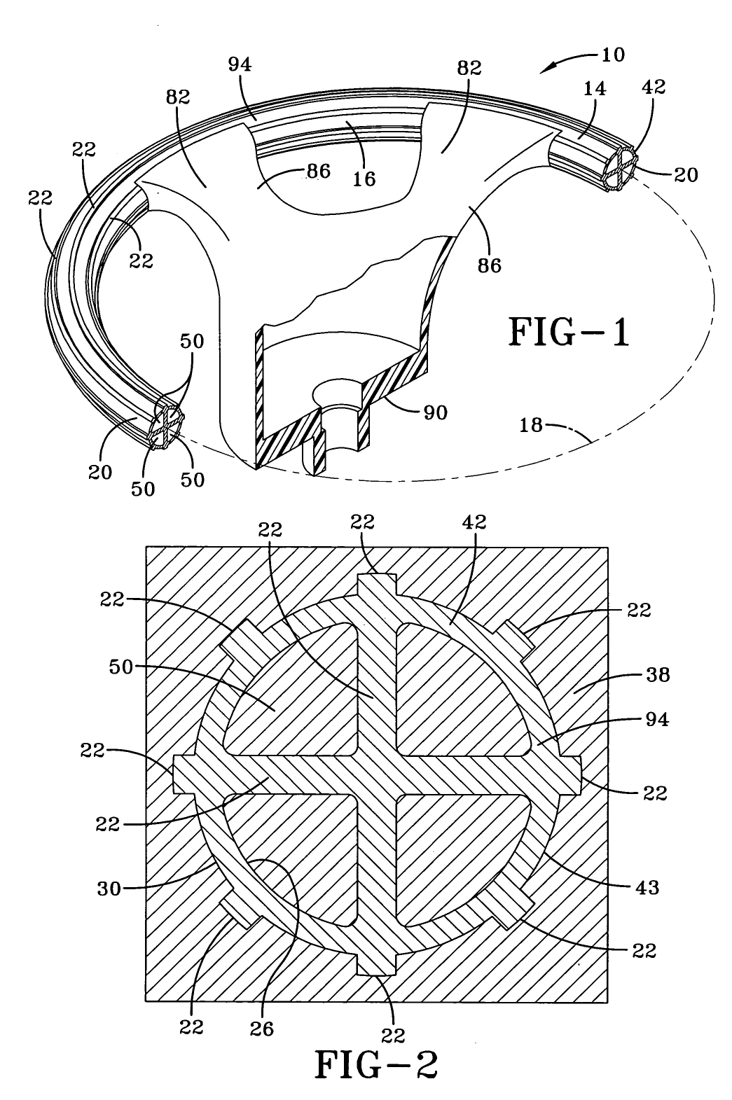

FIG. 1 illustrates a cross-sectional perspective view of inventive steering wheel assembly 10. Steering wheel assembly 10 has steering wheel rim 14 extending around perimeter 18. Steering wheel rim 14 has inner circumference 16 and outer circumference 20. Like conventional steering wheel assemblies, steering wheel assembly 10 also has steering wheel armature 82, which attach steering wheel rim 14 to spokes 86. Spokes 86 are attached to hub 90.

Steering wheel rim 14 is an extrusion formed from a die as shown in FIG. 2. Die 38 has opening 43 shaped like cross-section 42 of steering wheel rim 14. Cross-section 42 is a cross-section of steering wheel rim 14 in a direction perpendicular to periphery 18 as shown in FIG. 1. Here, cross-section 42 is a continuous, unbroken ring.

Steering wheel rim 14 has reinforcing supports 22, which are formed on interior surface 26 and exterior surface 30 of steering wheel rim 14. These reinforcing supports 22 are extrusions and are also formed by die 38 as shown in FIG. 2. In addition, die 38 forms interior volume 50 of steering wheel rim 14. Consequently, less material may be used to form steering wheel rim 14 than in other conventional methods. Reinforcing supports 22 strengthen steering wheel rim 14.

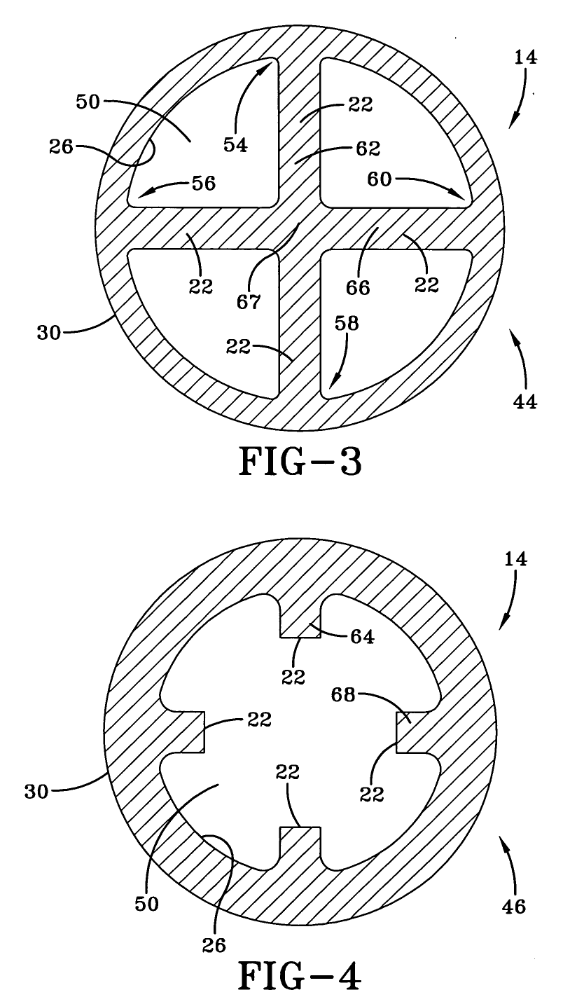

FIG. 3 shows an alternative cross-section 44 for steering wheel rim 14. The difference between the cross-section 42 of FIG. 2 and the cross-section 44 of FIG. 3 is the absence of reinforcing supports 22 on exterior surface 30 of steering wheel rim 14. Instead, reinforcing supports 22 are only provided on interior surface 26. Furthermore, first reinforcing support 62 extends from first location 54 to second location 58 of interior surface 26 across interior volume 50. Similarly, second reinforcing support 66 is attached at third location 56 and fourth location 60 of interior surface 26. Both reinforcing supports 62 and 66 meet at intersection 67.

FIG. 4 illustrates cross-section 46. Here, in contrast to cross-section 44 of FIG. 3, reinforcing supports 22 do not extend entirely across interior volume 50. Instead, steering wheel rim 14 is provided with reinforcing supports 22 that protrude above interior surface 26 but do not intersect.

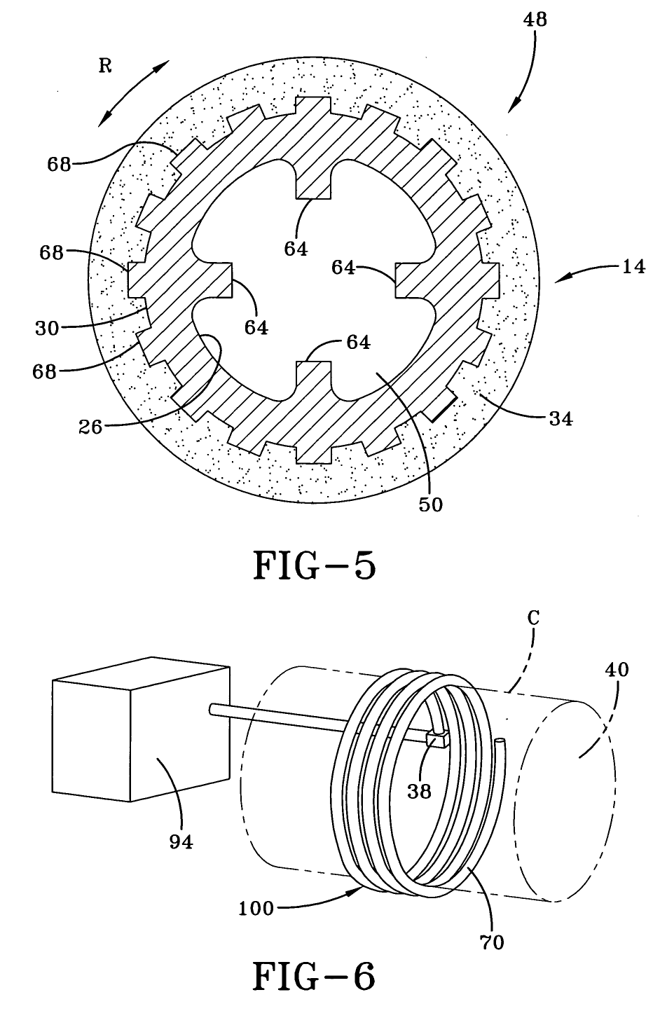

FIG. 5 illustrates another alternative cross-section, cross-section 48, here having both reinforcing supports 64 on interior surface 26 and reinforcing supports 68 on exterior surface 30 of steering wheel rim 14. In addition, filler material 34 is molded onto exterior surface 30 of steering wheel rim 14. As shown, reinforcing supports 68 not only strengthen steering wheel rim 14 but prevent rotation of filler material 34 along arc R. Accordingly, reinforcing supports 68 prevent filler material 34 from being twisted on steel wheel rim 14 by a vehicle driver.

Cross sections 42, 44, 46 and 48 are all formed by a die, such as die 38, having a shape to form by extrusion the foregoing cross-sections. Steering wheel rim 14 may be made from material 94, such as plastic, magnesium, aluminum or other extrudable material. A plastic, such as LEXAN EXL™ resin made by the GENERAL ELECTRIC COMPANY™, may be used.

The technique for extruding steering wheel rim 14 will now be explained with reference to FIGS. 6-8. As shown in FIG. 6, die 38 is provided with a source of material 94 in an extrudable state. At pressure, material 94 is passed through die 38 and formed around form 40, a cylinder having circumference C, which is about the circumference of inner circumference 16 of steering wheel rim 14 as shown in FIG. 1. Following the extrusion of material 94 through die 38, as shown in FIG. 7, a segment 98, here a loop having inner circumference C, is cut from extruded material 100. Hence, tube 70 having first end 74 and second end 78 is formed.

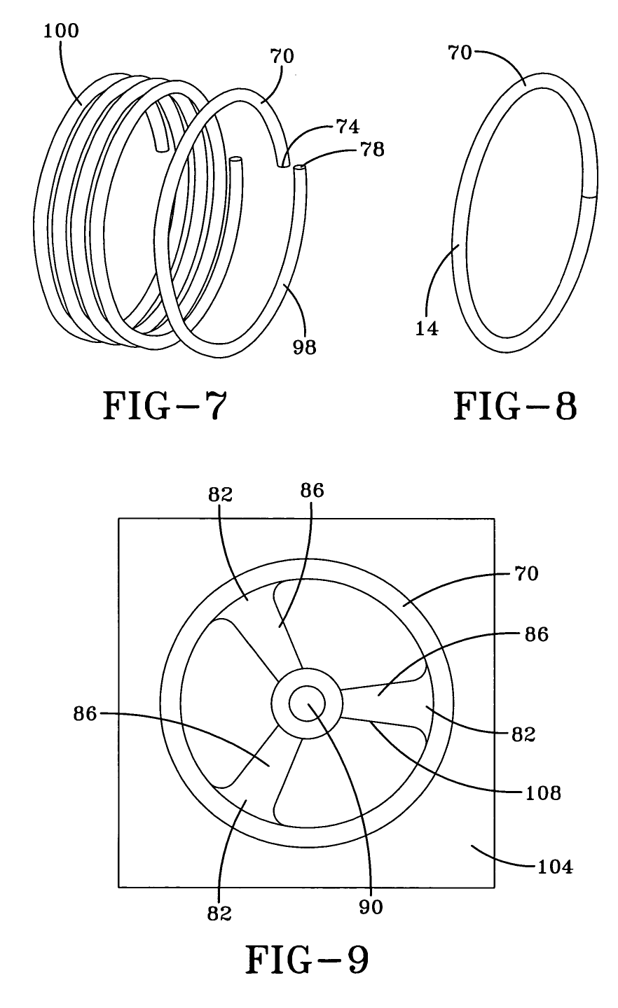

As shown in FIG. 8, first end 74 and second end 78 of tube 70 are joined, such as by mating plugs or other connectors. In this way, as can be seen, multiple steering wheel rims 14 may be formed quickly and with very little expense from extruded material 100. As shown in FIG. 9, tube 70 may then be placed in mold 104. Mold 104 is provided with a form 108 in which steering wheel armature 82, spokes 86 and hub 90 may be molded to tube 70.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A steering wheel assembly, comprising:
a steering wheel rim extending around a perimeter;
a reinforcing support extending at least partially around said perimeter and formed on said steering wheel rim; and
said steering wheel rim having an interior surface and an exterior surface, said reinforcing support protruding from at least one of said interior surface and said exterior surface.

2. The steering wheel assembly of claim 1 wherein said reinforcing support is located on said exterior surface of said rim.

3. The steering wheel assembly of claim 2 including a filler material on said exterior surface, said reinforcing support preventing said filler material from-rotating-about said rim.

4. The steering wheel assembly of claim 1 wherein at least one of said steering wheel rim and said reinforcing support comprises an extrusion.

5. The steering wheel assembly of claim 4 wherein both said steering wheel rim and said reinforcing support comprise an extrusion from the same die.

6. The steering wheel assembly of claim 1 wherein said steering wheel rim has a cross section transverse to said perimeter, said cross section forming a continuous ring.

7. The steering wheel assembly of claim 1 wherein said rim has an interior volume, said reinforcing support extending across said interior volume and attached to a first location and a second location of said interior surface of said interior volume.

8. The steering wheel assembly of claim 1 wherein said reinforcing support comprises a first reinforcing support and a second reinforcing support, said first reinforcing support spaced from said second reinforcing support.

9. The steering wheel assembly of claim 8 wherein said first reinforcing support is located on said interior surface and said second reinforcing support is located on said exterior surface.

10. The steering wheel assembly of claim 8 wherein said steering wheel has a cross section transverse to said perimeter, said first reinforcing support spaced from said second reinforcing support in said cross section.

11. A method of manufacturing a steering wheel assembly, the method comprising the steps of:
A) extruding a material through a die; and
B) forming the material into a steering wheel rim.

12. The method of claim 11 including the following step:
C) forming a tube having a first end and a second end from the extruded material.

13. The method of claim 12 wherein step B) comprises attaching said first end to said second end.

14. The method of claim 11 including the following step:
D) forming a reinforcing support on the material.

15. The method of claim 14 wherein the reinforcing support is formed from the die during step A).

16. The method of claim 14 wherein the reinforcing support is formed on an exterior surface of the steering wheel rim.

17. The method of claim 14 wherein the reinforcing support is formed on an interior surface of the steering wheel rim.

18. The method of claim 11 including the following step:
E) molding at least one of a steering wheel armature, a spoke and a hub to the steering wheel rim.

19. A steering wheel assembly comprising:
a steering wheel rim extrusion extending around a circumference;
a reinforcing support extrusion extending at least partially around said circumference formed on said steering wheel rim extrusion; and
said steering wheel rim having an interior volume, an interior surface and an exterior surface, said reinforcing support protruding from at least one of said interior surface and said exterior surface.

20. The steering wheel assembly of claim 19 wherein said steering wheel rim extrusion and said reinforcing support extrusion are formed by the same die.
